(19) United States
(12) Patent Application Publication
(10) Pub. No.: US 2004/0028977 A1
(43) Pub. Date: Feb. 12, 2004

(54) Fuel cell incorporating a modified ion exchange membrane

(76) Inventors: Peter Pickup, St John's Newfoundland (CA); Zhigang Qi, New Jersey, NJ (US); Nengyou Jia, Richmond British (CA)

Correspondence Address: STERNE, KESSLER, GOLDSTEIN & FOX P.L.L.C., 1100 NEW YORK AVE., N.W., WASHINGTON, DC, 20005, US

(21) Appl. No.: 10/296,707

(22) PCT Filed: May 30, 2001
(86) PCT No.: PCT/CA01/00767

(30) Foreign Application Priority Data
May 30, 2000 (CA) 2,310,310

(51) Int. Cl. H01M 8/10; C08J 5/22

(52) U.S. Cl. 429/33; 521/27

(57) ABSTRACT

The present invention provides a fuel cell that comprises a modified ion exchange membrane. The present invention additionally provides modified membranes produced by in situ polymerisation of monomers, such as aryls, heteroaryls, substituted aryls, substituted heteroaryls or a combination thereof, on and/or within an ion exchange membrane. The modified membranes can exhibit reduced permeability to fuel crossover in comparison to the unmodified membranes, often without a significant increase in ionic resistance. the present invention further provides methods for preparing and testing, or evaluating, the modified membranes and fuel cell comprising the modified membranes.

### FIELD OF THE INVENTION

The present invention pertains to the field of fuel cells and more particularly to organic fuel cells.

### BACKGROUND

Ion exchange membrane fuel cells are considered a leader in the race to offer zero or low emission vehicular power plants to market. These fuel cells continuously convert chemical energy of a fuel oxidation reaction into electrical energy. At the anode, fuel molecules are oxidized donating electrons to the anode, while at the cathode the oxidant is reduced accepting electrons from the cathode. The ions formed at the anode migrate through the electrolyte to the cathode and combine with the oxidant to form a reaction product, completing the electric circuit. The anode and cathode compartments of the fuel cell are separated by an ion exchange membrane, typically a polymer ion exchange membrane.

One type of ion exchange membrane used in a fuel cell is the proton exchange membrane (PEM). Hydrogen is the cleanest available fuel, but engineering, public perception and, particularly, economic difficulties regarding its supply and use impede market penetration. The on-board chemical reforming of safer hydrogen-producing fuels that are more acceptable to the consumer is a possible solution to these problems.

Propane, methanol and other readily available organic compounds are candidate fuels. Disadvantages of this strategy are slow stack startup due to the temperature requirements of the reformer and shift reactor and the considerable complexity and added expense this hardware adds to the power plant. A simpler approach is the use of such safe fuels without reforming. The direct methanol fuel cell (DMFC) is the strongest contender of this type.

The DMFC however, shows considerably lower performance than the hydrogen fuel cell because of inefficient methanol oxidation and “crossover.” In fuel cell technology, the term “crossover” refers to the undesirable transport of fuel through the polymer electrolyte layer from the fuel electrode or anode side to the air/oxygen electrode or cathode side of the fuel cell. Crossover wastes methanol fuel and causes performance losses at the cathode due to consumption of oxygen and catalyst poisoning. If these problems can be effectively addressed, the DMFC will offer the best chance for fuel cell commercialization in private vehicles.

A number of different approaches have been taken to mitigate the effects of methanol crossover in PEM fuel cells. Theses efforts include changing operational parameters such as the flow rate, concentration and temperature of the fuel mixture, using different cathode catalysts and cell designs, trying alternate fuels or fuel mixtures and developing polymer ion exchange membranes that are less permeable to methanol.

Savinell and coworkers (J.-T. Wang et al. (1996) J. Appl. Electrochem. 26:751-756) have used polybenzimidazole membranes doped with phosphoric acid. These are similar to molten salts, requiring little or no water for high proton conductivity, and can be operated at higher temperatures (≈200 ° C.) than conventional PEMs. Their methanol crossover rates are about an order of magnitude less than for unmodified sulphonated fluorocarbon membranes. Other membranes with low methanol permeabilities compared to sulphonated fluorocarbon membranes include electrochemically polymerized sulphonated polyoxyphenylene (A. Kuver and K. PotjeKamloth (1998) Electrochim. Acta 43:2527-2535), and various polymer blends containing sulphonated Polysulfone Udel® or sulphonated poly(etheretherketone) (M. Walker et al. (1999) J. App. Polym. Sci. 74:6773).

To the end of decreasing methanol crossover in conventional PEMs, a number of different composite membrane structures have been proposed. For example, U.S. Pat. No. 5,672,438 describes the lamination of ionomer layers of sulphonated fluorocarbons of different equivalent weight (EW). High EW ionomers are reportedly very impermeable to methanol independent of layer thickness. Thus a very thin, high EW methanol blocking layer can be laminated to the usual, ca. 1000 EW layer providing reduction of crossover while not greatly affecting proton conductivity. Additionally, the partial blockage of methanol crossover has been attempted with non-ion exchange polymer support layers (U.S. Pat. No. 5,795,668), laminated structures with nanometer thick Pd or Pt foils (C. Pu et al. (1995) J. Electrochem. Soc., 142:L119-120), and layers of plasma polymerized hexane (Walker et al., supra). In another approach, zirconyl phosphate has been precipitated within the pores of the ionomer (U.S. Pat. No. 5,849,428). The current art of methanol oxidation and crossover in DMFCs is reviewed in S. Wasmus and A. Kruver (1999) J. Electroanal. Chem., 461:14-31 and in A. Heinzel and V. M. Barragan (1999) J. Power Sources, 84:70-74.

Of the various types of membranes previously studied, sulphonated fluorocarbon membranes, such as Nafion™, are commercially available and have served as a good model for research on methanol crossover reduction in general. The impregnation of such sulphonated fluorocarbon membranes with polymers by in situ polymerization is well known (F.-R. F. Fan and A. J. Bard (1986) J. Electrochem Soc., 133:301-304; T. Sata, (1991) Chem. Mater., 3:838-843; M. Fabrizio et al. (1991) J. Electroanal. Chem., 300:23-34). Some reports suggest the use of such composites as catalyst materials or supports for fuel cells (Fabrizio et al., supra; M. Morita et al. (1996), Denki Kagaku, 64:749-751). However the use of these materials to reduce methanol permeability in the membranes of fuel cells has not been addressed.

There is a need for a method to modify membranes for use in fuel cells wherein fuel crossover is significantly decreased without a significant increase in ionic resistance. The use of such modified membranes in fuel cells would result in fuel conservation while providing comparable performances to that of unmodified membranes in fuel cells.

### SUMMARY OF THE INVENTION

An object of the present invention is to provide a fuel cell incorporating a modified ion exchange membrane. In accordance with an aspect of the present invention, there is provided a fuel cell for use with a fuel, comprising: an anode; a cathode; and an ion exchange membrane modified by in situ polymerisation of monomers on and/or within the membrane, wherein the monomers are aryls, heteroaryls, substituted aryls, substituted heteroaryls or a combination thereof.

An object of the present invention is to provide an improved organic fuel cell that demonstrates diminished permeability to fuel crossover.

Another object of the present invention is to provide an improved organic fuel cell that demonstrates diminished permeability to fuel crossover without significantly increasing ionic resistance.

In accordance with another aspect of the invention, there is provided a method for preparing a fuel cell comprising the step of modifying an ion exchange membrane by in situ polymerisation of monomers on and/or within the membrane, wherein the monomers are aryls, heteroaryls, substituted aryls, substituted heteroaryls or a combination thereof.

In accordance with another aspect of the invention, there is provided a use of a modified membrane in a fuel cell, wherein said modified membrane is produced by in situ polymerisation of monomers on and/or within an ion exchange membrane, and wherein said monomers are aryls, heteroaryls, substituted aryls, substituted heteroaryls or a combination thereof.

In accordance with another aspect of the invention, there is provided a modified membrane, for use in a fuel cell, produced by in situ polymerisation of monomers on and/or within an ion exchange membrane, wherein said monomers are aryls, heteroaryls, substituted aryls, substituted heteroaryls or a combination thereof.

In accordance with another aspect of the invention, there is provided a method of evaluating the improved organic fuel cell.

### BRIEF DESCRIPTION OF THE DRAWINGS

FIG. 1 shows the basic polymerisation reaction of 1-methylpyrrole in a sulphonated fluorocarbon membrane matrix.

FIG. 2 shows steady state voltammograms for methanol oxidation in half-cells with poly(1-methylpyrrole) modified and unmodified sulphonated fluorocarbon membranes.

FIG. 3 shows the methanol crossover current vs. cell resistance for poly(1-methylpyrrole) modified and unmodified sulphonated fluorocarbon membrane and electrode assemblies in a half-cell at 60° C.

FIG. 4 shows polarisation curves for ambient temperature Hydrogen (1 atm)/Oxygen (1 atm) fuel cells with poly(1-methylpyrrole) modified and unmodified sulphonated fluorocarbon membranes.

FIG. 5 shows polarisation curves for direct methanol fuel cells with poly(1-methylpyrrole) modified and unmodified sulphonated fluorocarbon membranes at 60° C. (1 M methanol and oxygen at 1 atm).

FIG. 6 shows the methanol crossover current relative to unmodified membranes vs. membrane resistance for polypyrrole modified and unmodified sulphonated fluorocarbon membrane and electrode assemblies in a half-cell at 22° C.

FIG. 7 shows the methanol crossover for unmodified and modified sulphonated fluorocarbon membranes at 50° C. in 1 M methanol.

FIG. 8 shows the methanol crossover for unmodified and modified sulphonated fluorocarbon membranes at 70° C. in 1 M methanol.

FIG. 9 shows the linear regression of Cottrell relationship for unmodified and modified membranes.

### DETAILED DESCRIPTION OF THE INVENTION

The present invention provides an organic fuel cell comprising a modified ion exchange membrane. The membrane is modified by in situ polymerisation of conjugated molecules such as aryls, heteroaryls, substituted aryls or substituted heteroaryls, on and/or within the ion exchange membranes. The modification of the ion exchange membrane using in situ polymerization can decrease fuel crossover while maintaining high ionic conductivity.

In one aspect of the present invention there is provided a fuel cell for use with organic fuels, such as, but not limited to, methanol, ethanol, trimethoxymethane, dimethoxymethane and acetal, and which comprises a membrane through which the ions released or consumed by oxidation of these fuels cross to/from the cathode. The membrane is either an anion exchange membrane or a cation exchange membrane, which has been modified by in situ polymerisation of a material containing ion exchange groups on and/or within the membrane.

In another aspect of the present invention a fuel cell is provided for operation with a direct feed organic fuel, which includes an anode compartment containing an anode, a cathode compartment containing a cathode and a membrane serving as a separator and electrolyte between the anode and cathode compartments. The membrane is either an anion exchange membrane or a cation exchange membrane, which has been modified by in situ polymerisation of a material containing ion exchange groups on and/or within the membrane. In one embodiment of the present invention the membrane is a polymer-modified cation exchange membrane and the organic fuel is methanol.

Preparing the Polymer-Modified Membrane for Use in the Fuel Cell

The fuel cell of the present invention comprises an organic fuel, an anode compartment, a cathode compartment, and an ion exchange membrane which has been modified with a polymer that has been polymerised on and/or within the membrane. This fuel cell has improved properties over those currently known in the art. For example, the fuel cell of the present invention can exhibit reduced fuel crossover, in comparison to fuel cells currently in use, as a result of the presence of the modifying polymer on and/or within the membrane.

Step 1: Selecting the Ion Exchange Membrane

A worker skilled in the relevant art would readily appreciate that any membrane that can be used in a fuel cell and can be modified by in situ polymerisation can be incorporated in the fuel cell of the present invention. There are a variety of membranes presently used within fuel cells, which are polymers of, for example, carboxylates, phosphonates, imides, sulfonimides and/or sulfonamides. In one embodiment the fuel cell comprises a carboxylate, phosphonate, imide, sulfonimide or sulfonamide polymer membrane modified according to the present invention.

Known cation exchange membranes that can be used according to the present invention, are formed from polymers that include, but are not limited to, polymers and copolymers of benzimidazole, trifluoroethylene, tetrafluoroethylene, styrene-divinyl benzene, and α,β,β-trifluorostyrene. In one embodiment the fuel cell comprises a benzimidazole, trifluoroethylene, tetrafluoroethylene, styrene-divinyl benzene or α,β,β-trifluorostyrene polymer membrane modified according to the present invention

Nafion™ and similar sulphonated fluorocarbons are the most widely used membrane materials for fuel cells because of their excellent long-term stability in fuel cells, and their high proton conductivities (typically ca 0.1 Ω⁻¹ cm⁻¹). However, the high cost of these materials and their poor performance at temperatures above ca. 130 ° C. mean that many alternative membranes can compete with Nafion™ for commercial application. Sulphonated trifluorostyrene based membranes provide similar performances in fuel cells but should be less costly (U.S. Pat. Nos. 5,773,480 and 5,834,523). In one embodiment the fuel cell comprises a sulphonated fluorocarbon membrane modified according to the present invention. In a related embodiment the sulphonated fluorocarbon membrane is Nafion™ or sulphonated trifluorostyrene.

Polybenzimidazole membranes doped with acids, such as phosphoric acid (Wang, J T et al. (1996) J. Appl. Electrochem. 26(7):751-756) or substituted with acidic groups, such as sulphonic acids (Kawahara,M et al. (2000) Solid State Ionics 136:1193-1196), allow operation of fuel cells at high temperatures. In one embodiment the fuel cell comprises a polybenzimidazole membrane modified according to the present invention. In a related embodiment the polybenzimidazole membrane is substituted with acidic groups.

Various composite membranes, such as Nafion™/zirconium phosphate composites (Yang,C et al. (2001) Electrochem. Solid. State. Lett. 4:A31-A34) show considerable promise. Additional membranes that can be used in direct methanol fuel cells have been discussed in several recent reviews (Wasmus,S; Kuver,A (1999) J. Electroanal Chem. 461:14-31; Heinzel,A; Barragan,V M (1999) J. Power Sources 84:70-74) and are well known to workers skilled in the art.

Selection of an ion exchange membrane, for use in the fuel cell of the present invention, is based on a number of criteria, including long-term stability, ion conductivity, temperature sensitivity, ion selectivity, etc. A worker skilled in the art would recognise that selection of an appropriate membrane is largely dependent on the application of the fuel cell as will be addressed in greater detail below. In one embodiment of the present invention the ion exchange membrane is a cation exchange membrane. Exemplary cation exchange membranes are sulphonated fluorocarbon membranes, such as Nafion™, which were chosen because of their high long-term stability and proton conductivity.

Step 2: Choosing the Modifying Polymer

A wide range of modifying polymers that exhibit anion exchange properties can be incorporated into the fuel cells of the present invention. Monomers required for the preparation of these polymers are available and can be deposited within or on membranes using techniques known to workers skilled in the art. There are many commercially available monomers that can be applied, including, but not limited to, pyrroles, thiophenes, anilines and derivatives thereof.

In one embodiment of the present invention the monomer can be chemically modified in order to alter the physical characteristics of the polymer product, for example, hydrophobicity can be increased with addition of alkyl substituents, or decreased with addition of acidic substituents (for a review see e.g.: Roncali,J (1999) J. Mater. Chem. 9:1875-1893; Skotheim,T A; Elsenbaumer,R L; Reynolds,J R (Eds.) (1998): Handbook of Conducting Polymers. 2nd ed. Marcel Dekker, New York; McCullough,R D (1998) Advan. Mater. 10:93). This allows the localization of different polymers in different regions of the membrane, i.e. on and/or within hydrophobic backbone regions, hydrophilic pores, or interfacial regions. In a specific embodiment of the present invention, the use of acidic functional groups can improve proton conductivity in the modified membranes.

As with the choice of the ion exchange membrane, a number of criteria are applied in choosing the appropriate modifying polymer, including stability, cost, hydrophobicity or hydrophilicity, etc. A worker skilled in the art would recognise that selection of appropriate monomers is largely dependent on the application of the fuel cell.

Stability is best assessed by performing long-term testing in an operating fuel cell in order to examine the stability of the polymer over time and under various conditions. The initial performance of the cell should be maintained over thousands of hours without a corresponding increase in the methanol crossover rate. The methanol crossover rate can be measured in the fuel cell using standard methods known to workers skilled in the art (e.g.: Ren, X M et al. (2000) J. Electrochem. Soc. 147:466-474).

Stability can also be assessed in ex situ experiments in which the modified membrane, formed from in situ polymerisation of the monomer, is exposed to various extreme conditions, such as long periods in boiling or superheated water. In these studies the amount of modifying polymer that remains unaffected in the membrane is measured by UV-visible absorption spectroscopy, and the methanol permeability of the membrane is measured in a half-cell. In these studies, initial measurements are taken and compared to measurements taken following exposure to the extreme conditions to determine any change in the modified membrane. Significant change is indicative of a degree of instability of the polymer. The modified membranes that are used in the fuel cell of the present invention demonstrate little or no change when exposed to fuel cell operating conditions.

In one embodiment of the present invention the modifying polymer is polypyrrole, poly(1-methylpyrrole) or polyaniline.

Step 3: In Situ Polymerisation

In past attempts to prepare a membrane with reduced fuel crossover, membranes have been modified by techniques such as the lamination of one or more ion exchange layers, inorganic filler dispersement within the membrane and the embedding of support layers within the membrane. The present invention provides a novel method of modifying membranes to reduce fuel crossover, which comprises the in situ polymerization of molecules, such as pyrrole and 1-methylpyrrole, on and/or within the membrane. According to the present invention, in situ polymerisation of molecules on and/or within a membrane is not restricted to polymerisation on the surface of the membrane, but also includes polymerisation which is predominantly or exclusively within the membrane.

A crucial aspect of the invention is that the in situ formation of the polymer on and/or within the membrane does not cause electrons to be conducted across the thickness of the membrane, since this would short-out the fuel cell. However, electronic conduction across the surface of the membrane is acceptable, and may be desirable. Electronic conduction across the thickness of the membrane can be avoided by various methods, including limiting the quantity of polymer deposited on and/or within the membrane, and/or localisation of the polymer at one or both sides of the membrane or within a certain region of the membrane.

The step of in situ polymerisation is performed using standard techniques well known to workers skilled in the art (e.g.: Skotheim,T A; Elsenbaumer,R L; Reynolds,J R (Eds.) (1998): Handbook of

Conducting Polymers. 2nd ed. Marcel Dekker, New York). The method used for in situ polymerization can influence the modifying polymer distribution, both locally and across the membrane. For example, the use of chemical oxidants (e.g. Fe³⁺, persulphates, H₂O₂) allows the modifying polymer to be localised in a thin dense layer that effectively blocks fuel transport without greatly increasing resistance. One technique for in situ polymerization using chemical oxidants uses the membrane as a separator for the monomers and the oxidant. The polymer grows where the monomers and the oxidant meet, which is controlled by the charge on the oxidant and the properties of the monomer.

Various oxidizing agents are known to those skilled in the art to be effective for in situ polymerisation (e.g.: Chao,T H; March,J (1988) J. Polym. Sci., Part A, Polym. Chem. 26:743-753; Castillo-Ortega,M M; Inoue,M B; Inoue,M (1989) Synthet. Metal 28:C65-C70; Armes,S P; Aldissi,M (1991) Polymer 32:2043-2048. Kang,E T et al. (1986) Polymer 27:1958-1962; Mohammadi et al. (1987) Synthet. Metal 21:169-173; Armes,S P (1987) Synthet. Metal. 20:365-371; Nishio,K et al. (1996) J. Appl. Electrochem. 26(4):425-429; Armes,S P; Miller,J F (1988) Synthet Metal. 22:385-393). According to the present invention oxidizing agents that can be used for the synthesis of the modifying polymer on and/or within the membrane, include, but are not limited to, Fe³⁺, (NH₄)₂S₂O₈, K₂S₂O₈, Cu²⁺. In one embodiment of the present invention, an oxidising agent such as Fe³⁺, (NH₄)₂S₂O₈, H₂O₂, O₂, or air is used to polymerise the monomers. In an alternative embodiment UV irradiation is used to promote polymerisation of the monomers.

Standard polymerisation techniques known to those skilled in the art may be adapted for use in in situ polymerisation to modify ion exchange membranes according to the present invention. For example, alternative embodiments of the present invention make use of free radical and acid mediated in situ polymerisation in preparing modified membranes for use in the fuel cell.

Step 4. Washing the Membrane After In Situ Polymerisation

Following completion of the polymerisation reaction the polymer-modified membrane requires washing before it can be tested in an experimental fuel cell or actual fuel cell. The washing step ensures termination of in situ polymerisation, removal of unreacted monomers and oligomer by-products, clearance of impurities and/or rehydration of the modified membrane.

Various membrane washing protocols are known to those skilled in the art and can be adapted for use in the preparation of the modified membrane of the present invention. The washing protocol can simply involve immersion of the modified membrane in boiling water for a specified period of time or can involve a series of washing steps, as demonstrated in the Examples.

Evaluation of the Modified Membrane

Certain characteristics of the modified membrane are evaluated prior to its incorporation in the organic fuel cell of the present invention. Routine characterisation of the modified membranes includes:

Gravimetric analysis to determine the loading of the modifiers on and/or within the membrane. Results are validated using elemental analysis to confirm compositions and account for residual hydration. Water and methanol uptake by the modified membranes, as functions of temperature, humidity and methanol mole fraction, can be determined by the combination of gravimetry and gas chromatography.

Transmission and scanning microscopy are used to investigate modifier distributions. The use of polymers containing heavy atoms, such as iodine, can be necessary to allow the modifier to be more easily observed and quantified by microprobe analysis (EDX).

UV-Visible spectroscopy is used to determine the degree of oxidation of the modifying polymer, which is an indicator of positive charge.

Measurement of the ionic resistance or conductivity of the modified membrane. This can be done by impedance measurements on a piece of the membrane sandwiched between two inert metal electrodes (eg. Pt black). These measurements are usually made on membranes that have been fully hydrated by immersion in water for at least 1 hour.

Functional studies of the modified membranes are useful for evaluation of the modified membranes for use in the fuel cell of the present invention in various applications. Certain characteristics of the modified membranes make them more or less suitable for different applications. The membranes can be further evaluated in two types of cells; half-cells and fuel cells.

Half-Cell Experiments

Half-cell experiments are performed to evaluate various properties of the modified membranes and to identify those that are useful in the fuel cell of the present invention. It would be readily appreciated by a worker skilled in the art that results obtained from half-cell experiments are predictive of the performance of the modified membrane in a fuel cell. For example, these tests can be performed at room temperature or higher and the results have been found to correlate to those obtained using the modified membrane in a fuel cell operated at the higher temperatures, which are typical to fuel cells in operation (e.g. 90-130° C. in DMFCs). Standard techniques for preparing half-cells and for utilising them in the evaluation of membranes are well known to workers skilled in the art

The half-cell experiments can be performed using electrochemical measurement systems available from a variety of suppliers. Examples of systems used include, but are not limited to, a Solartron/Scblumberger 1286 Electrochemical Interface with 1250 Frequency Response Analyser, and an EG&G PAR 237A Potentiostat with 5210 Lock-in Amplifier.

A half-cell can be used to measure the fuel permeability of the membrane, or fuel crossover. A half-cell in which the membrane separates a fuel containing electrolyte solution from a fuel cell gas diffusion electrode can be used to quantify fuel permeation as a function of concentration and temperature. Fuel crossover rates, evaluated from the diffusion controlled oxidation current for fuel passing through the membrane, are separated into diffusion coefficients and partition coefficients by also using current transients from potential step experiments. The degree of fuel crossover can also be calculated from the amount of fuel found diffused across the membrane as measured by, for example, electrochemical methods, spectroscopic methods (e.g. IR spectroscopy and mass spectroscopy) and gas chromatography.

In one embodiment of the present invention the fuel cell is a methanol fuel cell. One type of half-cell that is used for testing the membranes of methanol fuel cells contains H₂SO₄ plus methanol. Membrane and electrode assemblies (MEA) are prepared by bonding the membrane to a carbon fibre paper (CFP) electrode catalysed with Pt black (both the CFP and catalyst layer contain PTFE). In the cell, the membrane side of the MEA is exposed to an aqueous solution of H₂SO₄ and methanol, while the CFP side is exposed to a flow of dry nitrogen. The area of the MEA exposed to the electrotrolyte is ca. 0.7 cm² in some experiments and ca. 0.3 cm² in others. Steady state voltammograms for oxidation of methanol that diffuses through the membrane to the catalyst layer are recorded by measuring the steady state current, typically after an equilibration period, at a series of potentials. The limiting current at higher potentials is proportional to the rate of methanol crossover, or the flux of methanol across the membrane.

The cell conditions used for methanol permeation experiments are the same as those commonly used for liquid-feed DMFCs, other than the replacement of oxygen by nitrogen.

The nitrogen is not humidified as the membrane is contacted by an aqueous H₂SO₄ electrolyte containing 1 M methanol. The permeation of methanol is measured electrochemically by monitoring methanol electro oxidation at the nitrogen electrode. The methanol flux through the membrane is determined from the measured mass transport limited current, i.e. the plateau of a steady-state voltammogram. Assuming that the unmodified membrane is pinhole free, the observed iₗᵢₘ from methanol permeation through the membrane can be expressed, in general, as follows

1/iₗᵢₘ=d/nFADₘCₘ (1)

where, Dₘ is the diffusion coefficient of methanol in the membrane; Cₘ is the methanol concentration in the membrane; and d is the thickness of the membrane. 1/iₗᵢₘ denotes the resistance of methanol transport through the membrane.

The methanol flux obtained from the permeation experiments can be further dissected into corresponding partition and diffusion coefficients, based on values of CₘDₘ^{1/2} obtained, according to the Cottrell relationship, from potential step experiments:

i=nFACₘ(Dₘ)^{1/2}/(πt)^{1/2} (b 2)

Dₘ and Cₘ can be determined using DₘCₘ values obtained from the limiting currents and CₘDₘ^{1/2} values obtained from the Cottrell analysis.

The best modified membranes are characterised by a low crossover current (iₗᵢₘ) and a low ionic resistance (R_{membrane}). Thus the product of iₗᵢₘ and R_{membrane} should be minimised by modification of the membrane. For low current density applications (<10 mA cm⁻²) such as consumer electronics (Dyer,C K (1999 Sci. Amer. 281:88-93), an increase in R_{membrane} is acceptable and so minimisation of iₗᵢₘ is most important. For high current applications (>100 mA cm⁻²), particularly automotive applications (Ralph,T R; Hards,G A (1998) Chem. Ind. 4(9):337-342; Appleby,A J (1999) Sci. Amer. 281:74-79.), R_{membrane} must also be minimsed.

Construction and Evaluation of the Fuel Cell

The components of the improved fuel cell are assembled using standard procedures known to those skilled in the art. Once assembled, the performance characteristics of the fuel cell can be tested. In particular the ionic conductivity and overall performance of the modified membrane within the fuel cell can be determined. Fuel crossover can also be measured in the fuel cell, however, the results from the fuel cell tests are less reliable than those obtained from the half-cell experiments described above.

An exemplary organic fuel cell according to the present invention makes use of methanol as the fuel. One type of fuel cell used to assess the effects of membrane modification on a methanol fuel cell performance consists of a membrane and electrode assembly and a plexiglass cell body with gas/solution inlets and outlets to allow the fuel (hydrogen or aqueous methanol) and oxidant (oxygen) to be passed over the anode and cathode, respectively. Electrical contact to the gas diffusion electrodes was made by Pt rings in pressure contact with each side of the MEA. In order to evaluate the performance of the modified membrane it is not necessary to design the fuel cell or the gas diffusion electrodes to provide optimum fuel cell performance. As such, during evaluation, performances can be found to inferior to those reported in the literature (e.g. Yang,C et al. (2001) Electrochem. Solid State. Lett. 4:A31-A34). The results, however, are of value for comparative purposes, and demonstrate that methanol crossover can be blocked without incurring a performance penalty. A worker skilled in the art would readily appreciate that it can reasonably be predicted that a modified membrane that performs as well or better than an unmodified membrane during evaluation in a non-optimised cell will perform as well or better than an unmodified membrane in a state-of-the-art cell.

In one embodiment of the present invention MEAs can be prepared by bonding two CFP electrodes catalysed with Pt black to either side of a larger piece of membrane. Both the CFP and catalyst layer contain PTFE. In the cell, one side of the MEA is exposed to flow of dry oxygen, while the other is exposed to a flow of humidified hydrogen or a 1 M solution of methanol in water. The hydrogen can be humidified by passing it through water at ambient temperature. In some instances this water can be replaced with a 50% (v/v) methanol/water mixture in order to add methanol vapour to the anode gas stream, which allows the effect of methanol on the cathode performance to be evaluated. Alternatively, if nitrogen is passed through the cathode compartment, it allows methanol crossover to be measured as in the half-cell experiments where the flux of methanol reaching the fuel cell is measured by voltammetry. The active geometric area of the fuel cell is ca. 0.7 cm².

In one embodiment of the present invention the performances of membranes in fuel cells are evaluated from polarization curves obtained by stepping the cell potential to increasingly lower values and measuring the current after 30 seconds at each potential. The potential is returned to its initial open circuit value for 10 seconds between each step. Membrane resistances are measured by impedance spectroscopy at the open circuit potential.

Fuel cells are also tested over longer time periods and under a variety of conditions (e.g. constant potential or constant current, temperature, pressure, fuel and oxidant flow rates, relative humidities, and concentrations) as known to those skilled in the art Such tests allow the determination of optimum operating conditions, which may be different for modified and unmodified membranes, and are necessary to predict the performance of the fuel cell in specific applications.

In these tests, the performance of the fuel cell (currents at particular cell potentials, or average current or power over a certain potential range) should ideally be better for the modified membrane than for an unmodified membrane, and this performance advantage should be maintained over a period of many thousands of hours of operation. However, the fuel efficiency gain produced by the modified membrane will be of considerable value even in the absence of a gain in performance, and may still be of value if the fuel cell performance is diminished. For example, the modified membrane can produce a cost advantage if a thinner modified membrane can be used in place of a thicker unmodified membrane, due to decreased membrane material cost.

To gain a better understanding of the invention described herein, the following examples are set forth. It should be understood that these examples are for illustrative purposes only. Therefore, they should not limit the scope of this invention in any way.

### EXAMPLES

### Example 1

### Preparation of a Fuel Cell by Polymerizing 1-Methylpyrrole into a Sulphonated Fluorocarbon Membrane Matrix

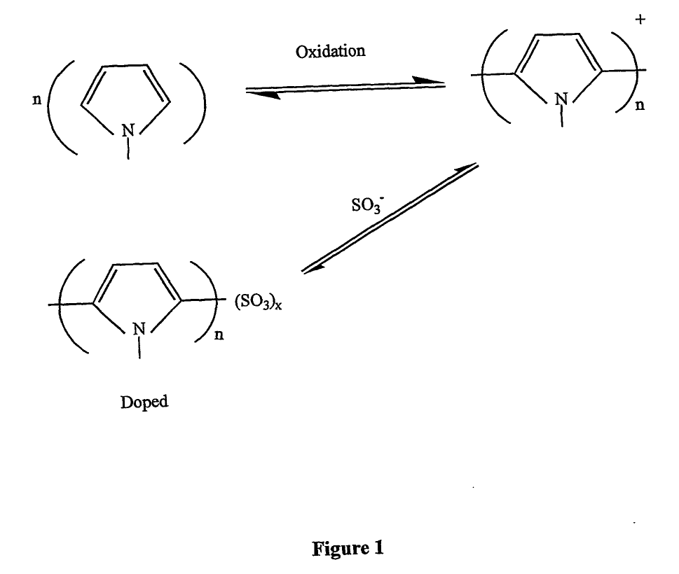

Membrane Modification: Nafion™ membranes are washed by a standard literature procedure, rinsed and then dried at 65° C. under vacuum for 24 h. They are then immersed in neat 1-methylpyrrole for between 50 s and 24 h, rinsed with ethanol, and then soaked in ethanol for several minutes. The 1-methylpyrrole within the membrane is then polymerised by one of two methods: i) exposing the membrane in air to radiation from a UV lamp for about 24 h, or ii) immersing the membrane in 30% hydrogen peroxide solution for up to 25 min. FIG. 1 shows the polymerisation reaction of 1-methylpyrrole onto the matrix of a sulphonated fluorocarbon membrane.

Post-Polymerisation Treatment: Following the polymerization, the modified membranes are immersed in boiling water for 2 h and then dried and stored in air. The modified membranes are cleaned and hydrated with methanol for 1 h, then with 1 M HNO₃ (aq) at 80° C. for 1 h, then with 1 M H₂SO₄ (aq) at 80° C. for 1 h, and finally rinsed with water.

Electrochemical Experiments: Membranes are evaluated in two types of cells: half-cells containing 1 M H₂SO₄+1 M methanol, and H₂/O₂ fuel cells with and without methanol vapour added to the H₂ fuel stream. The half-cell configuration is better for measuring the permeability of the membrane to methanol, while the fuel cell configuration allows more accurate measurement of the membrane's ionic conductivity and provides information on the membrane's overall performance in a fuel cell.

Half-cell Experiments: 1 cm² MEAs are prepared by bonding the membrane at 400 psi and 170° C. for 90 s to a CFP electrode catalysed with 4 mg Pt black per cm². Both the CFP and catalyst layer contain PTFE. In the cell, ca 0.3 cm² of the membrane side of the MEA is exposed to an aqueous solution of 1 M H₂SO₄+1 M methanol, while the CFP side is exposed to a flow of dry nitrogen. Steady state voltammograms for oxidation of methanol that diffuses through the membrane to the catalyst layer are recorded by measuring the steady state current, typically after an equilibration period of 60-120 s, at a series of potentials between +0.2 and +0.6 V vs SSCE. The limiting current at the higher potentials is proportional to the rate of methanol crossover, or the flux of methanol across the membrane.

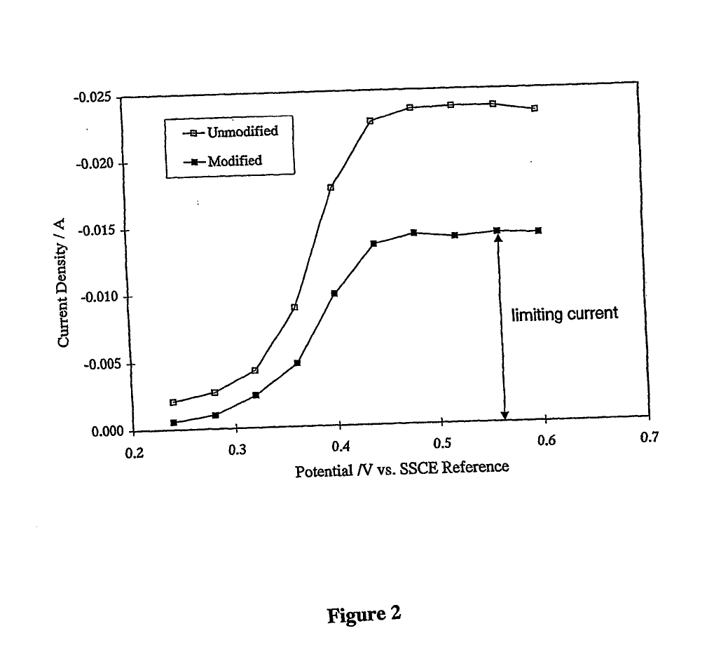

FIG. 2 shows a comparison between the limiting currents of unmodified and modified membranes. In this example, the membrane is modified with poly(1-methylpyrrole), by using UV irradiation to promote the in situ polymerization of 1-methylpyrrole in air. The limiting current with the modified membrane (14.2 mA) is significantly lower than that with the unmodified membrane (23.7 mA), indicating that the polymerization of poly(1-methylpyrrole) onto the membrane lowered its permeability to methanol by ca. 40%.

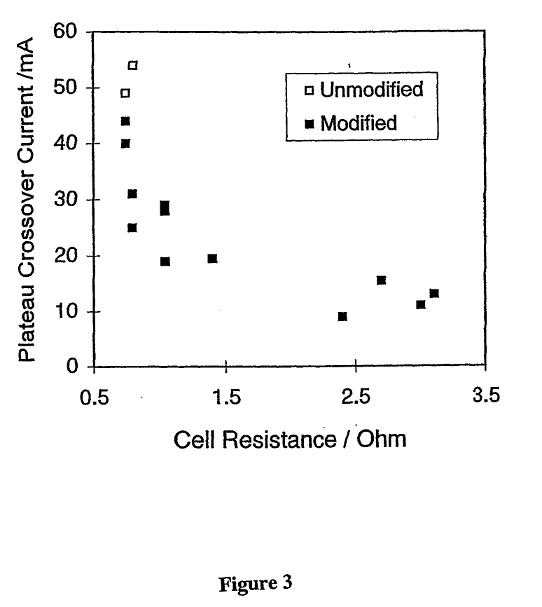

FIG. 3 shows a plot of methanol crossover current vs. cell resistance for a number of membranes, modified by in situ H₂O₂ polymerization of 1-methylpyrrole, tested in the half-cell (0.7 cm² of exposed membrane) at 60° C. The cell resistance here is the sum of the membrane's ionic resistance and a component from the resistance of the sulphuric acid solution. Since the latter is approximately constant, increases in the cell resistance above the value observed for the unmodified membranes (ca. 0.8 Ω) represent increases in the membrane resistance. It is clear from these results that methanol crossover can be curtailed by as much as 50% without a significant loss in membrane conductivity.

Fuel Cell Experiments: MEAs are prepared by bonding two 1 cm² CFP electrodes catalysed with 4 mg Pt black per cm² to either side of a larger piece of membrane. Both the CFP and catalyst layer contain PTFE. In the cell, one side of the MEA is exposed to a flow of dry oxygen, while the other is exposed to a flow of humidified hydrogen. The hydrogen is humidified by passing it through water at ambient temperature. In some experiments, the water is replaced by a 50% v/v methanol/water mixture to add methanol vapour to the anode gas stream.

The performances of membranes in the fuel cell are evaluated from polarization curves obtained by stepping the cell potential to increasingly lower values and measuring the current after 30 s at each potential. The potential is returned to its initial open circuit value for 10 s between each step to minimize the effects of water build-up in the cathode catalyst layer. Membrane resistances are measured by impedance spectroscopy at the open circuit potential, with nitrogen flowing over the fuel cell cathode.

Fuel Cell Interface Considerations

In addition to blocking methanol crossover while maintaining high proton conductivity, a practical membrane for a fuel cell must also form an effective interface with the fuel cell electrodes and allow sufficient water transport to prevent flooding or drying of the electrodes. Selected modified membranes were tested in a H₂/O₂ fuel cell, to ensure that these conditions are satisfied. In addition, methanol vapour is added to the H₂ fuel stream to investigate the effect of reduced methanol crossover on the performance of the cathode.

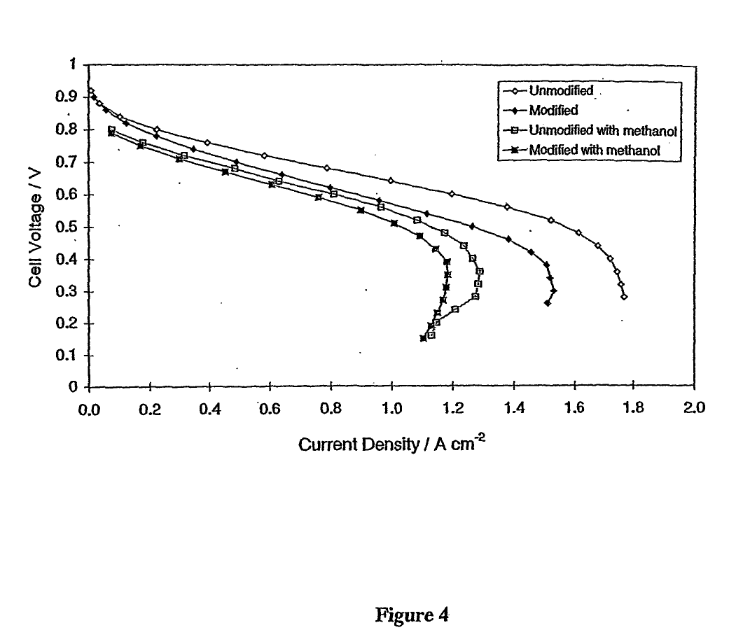

FIG. 4 shows polarization curves for fuel cells with modified and unmodified sulphonated fluorocarbon membranes. The performance of the modified membrane is slightly inferior to that of the unmodified membrane, and this can be attributed mainly to its slightly higher ionic resistance (0.19 Ω vs 0.16 Ω for the unmodified membrane). With methanol vapour added to the fuel the unmodified membrane is still slightly superior but the difference is smaller. Since the performance of the present invention's modified membranes is substantially similar to that of unmodified membranes, the modification has not seriously compromised their many characteristics required for use in a fuel cell. As these membranes show a 40% decrease in methanol crossover relative to unmodified membranes, they contribute to a more efficient fuel cell, because less fuel would be lost to crossover.

### Example 2

### Preparation of a Fuel Cell By Polymerizing 1-Methylpyrrole into a Sulphonated Fluorocarbon Membrane Matrix

Membrane Modification: Nafion membranes are washed by a standard literature procedure, rinsed and fully hydrated in water. They are then immersed in neat 1-methylpyrrole for 50 min, rinsed with ethanol, soaked in ethanol for several minutes, and then 30% hydrogen peroxide solution for 6 min. The membranes are then rinsed with water, and stored in water for several weeks.

Post-Polymerisation Treatment: The membranes are cleaned and hydrated with methanol for 1 h, then with 1 M HNO₃ (aq) at 80 or 100° C. for 1 h, then with 1 M H₂SO₄ (aq) at 80 or 100° C. for 1 h, and finally rinsed with water.

Ionic resistance. Samples of the modified membranes had ionic resistances that were 3.6 and 1.4 times higher than for an unmodified membrane, when washed with acids at 80 and 100° C., respectively.

Methanol Permeability. Samples of the modified membranes had methanol permeabilities at ambient temperature that were 8.3 and 2.0 times lower than for an unmodified membrane, when washed with acids at 80 and 100° C., respectively.

Permeability to dimethoxymethane. These measurements were made in a half-cell at ambient temperature as described for methanol permeation measurements. A sample of the modified membrane that had been washed with acids at 100° C., had a dimethoxymethane permeability that was 2.6 times lower than for an unmodified membrane.

Permeability to trimethoxymethane. These measurements were made in a half-cell at ambient temperature as described for methanol permeation measurements. A sample of the modified membrane that had been washed with acids at 100° C., had a trimethoxymethane permeability that was 2.2 times lower than for an unmodified membrane.

Permeability to ethanol These measurements were made in a half-cell at ambient temperature as described for methanol permeation measurements. A sample of the modified membrane that had been washed with acids at 100° C., had an ethanol permeability that was 2.0 times lower than for an unmodified membrane.

Permeability to acetal. These measurements were made in a half-cell at ambient temperature as described for methanol permeation measurements. A sample of the modified membrane that had been washed with acids at 100° C., had a acetal permeability that was 2.2 times lower than for an unmodified membrane.

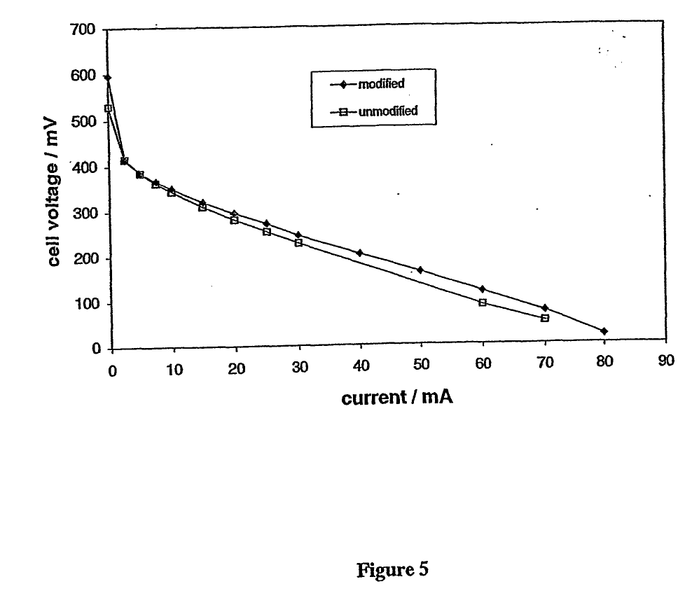

Direct methanol fuel cells. FIG. 5 shows polarization curves for direct methanol fuel cells comprising the modified membrane washed at 100° C., and an identical cell with an unmodified membrane. These data were obtained at 60° C. with 1 cm² electrodes catalysed with 4 mg Pt each, dry oxygen at 1 atm pressure at the cathode, and 1 M aqueous methanol as the fuel. The exposed electrode area was ca. 0.7 cm². Steady voltages at each current are reported. The two fuel cells show very similar performances. The modified fuel cell is therefore more efficient because its methanol crossover rate is half of that for the unmodified cell. In this example, there does not appear to be a significant efficiency gain from decreased poisoning of the cathode. However, the higher current densities and lower Pt loadings of commercial fuel cells will lead to higher susceptibility to cathode poisoning, and will therefore be improved more by modification of the membrane.

### Example 3

### Preparation of a Fuel Cell By Polymerising Pyrrole into a Sulphonated Fluorocarbon Membrane Matrix

Washed Nafion™ membranes are immersed in an aqueous pyrrole solution (typically 0.02 to 1 M) for a period of typically 10-200 min. They are then rinsed with water and stored in water, in the presence of ambient air, for a period of typically 1 to 10 days. The modified membranes may be washed by immersion in boiling water for several hours, and the other procedures specified in the examples above.

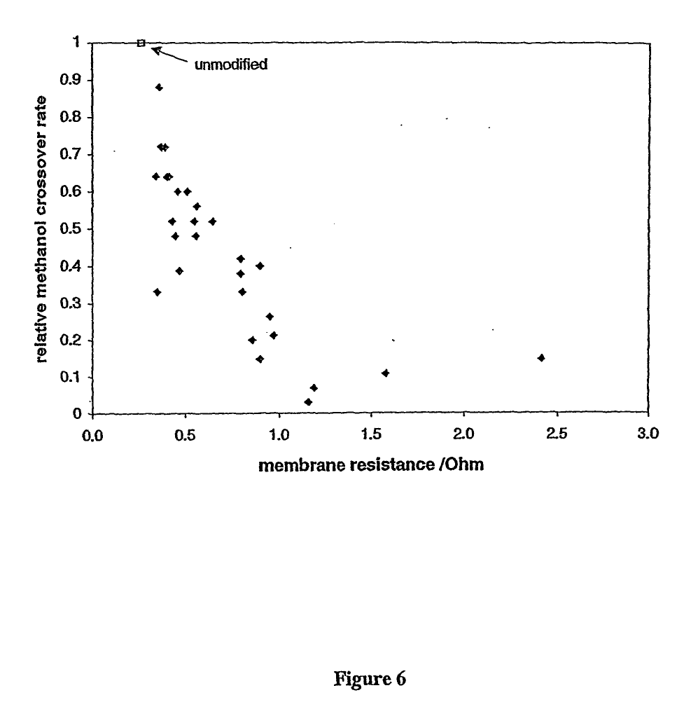

FIG. 6 shows a plot of relative methanol crossover rate vs. membrane resistance for 28 membranes modified with polypyrrole. Methanol crossover currents measured in half-cells have been normalised by dividing by the average crossover current measured for unmodified membranes. Membrane resistances were measured by impedance spectroscopy for fully hydrated membranes sandwiched between two fuel cell electrodes. The average resistance for the unmodified membrane was 0.26 Ω.

It is clear from the data shown in FIG. 6 that polymerisation of pyrrole into the membrane can decrease its permeability to methanol by more than 90%. Permeability can be decreased by more than 60% without a significant increase in membrane resistance.

### Example 4

### Preparation of a Fuel Cell By Polymerising Aniline into a Sulphonated Fluorocarbon Membrane Matrix

A washed and dried Nafion™ membrane is placed in aniline for 40 min, then rinsed with ethanol and placed in 30% H₂O₂ for 10 min. The modified membrane is boiled in water for 1 hour. Its permeability to methanol is then ca. 5 times lower than that of an unmodified membrane, while its ionic resistance is ca. 5 times higher. Similar results are obtained by modification of a membrane in 0.1 M aqueous aniline for 2 days in the presence of air, although the resistance is lower by a factor of ca. 2.

### Example 5

### Preparation of a Fuel Cell by Other Polymerisation Techniques

Similar results showing reduced methanol crossover have been obtained with sulphonated fluorocarbon membranes modified with the polymerization of 1-methylpyrrole, pyrrole and aniline by other polymerization methods. Some of these results are reported in N. Jia, “Electrochemistry of Proton-Exchange-Membrane Electrolyte Fuel Cell (PEMFC) Electrodes” (M.Sc. Thesis, Memorial University of Newfoundland, 1999).

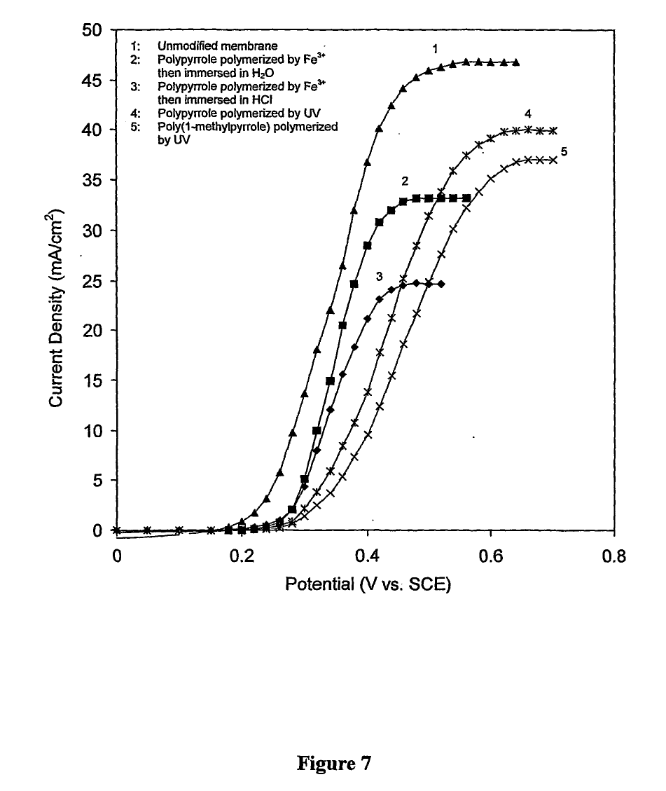

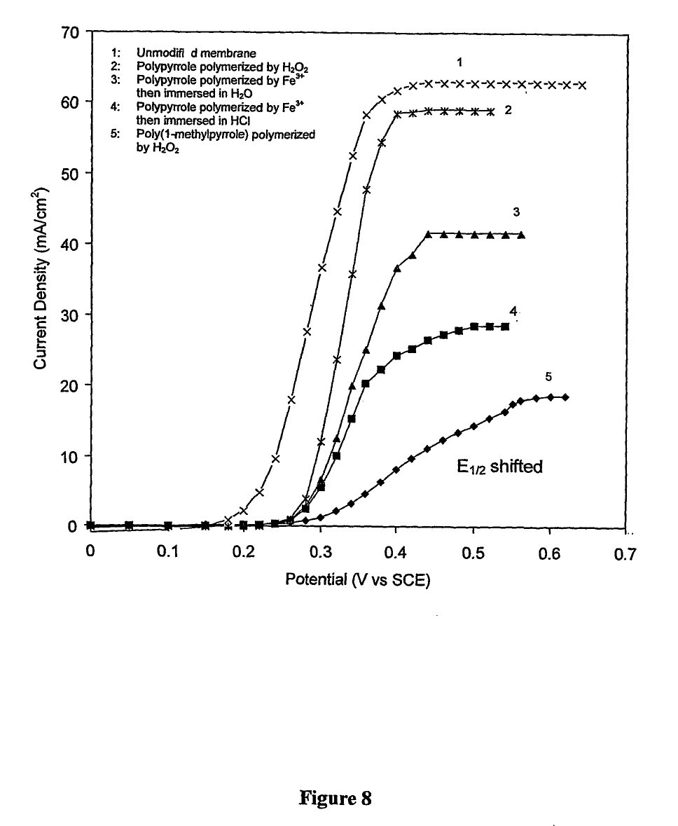

For example, membranes are evaluated in half-cell experiments at 50° C. and 70° C. in 1 M methanol as shown in FIGS. 7 and 8, respectively. The modified membranes show decreases in methanol crossover of as much as 70% as compared to the unmodified membranes.

The ionic resistances of the modified membranes are measured in a separate conductivity cell. Modification of the membranes by the H₂O₂ and UV methods do not significantly increase their ionic resistance, although resistance increases are observed in membranes polymerised with the Fe³⁺ and (NH₄)₂S₂O₈ oxidizing agents.

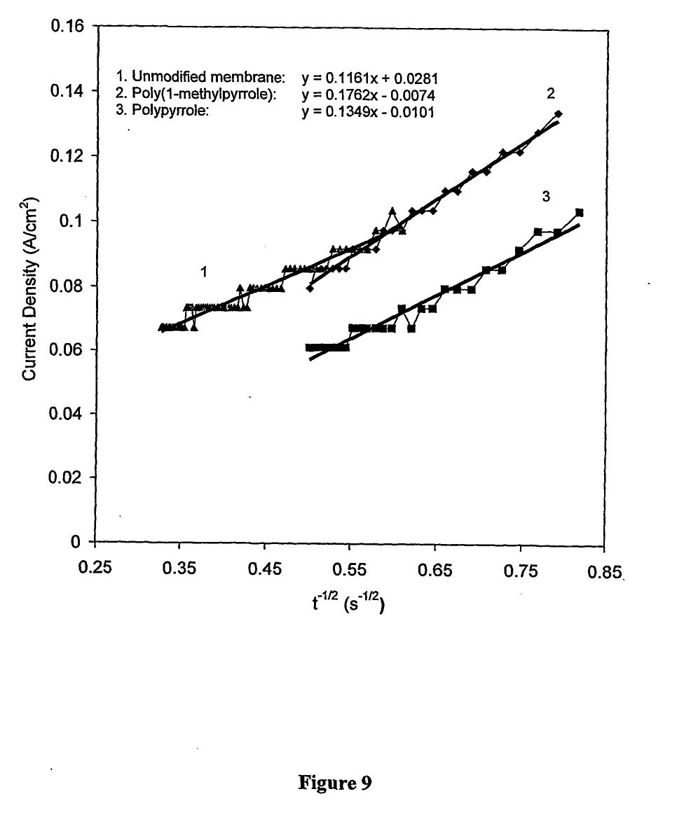

Typical Cottrell plots are shown in FIG. 9. These results are obtained in response to a potential step from 0 to 0.70 V (SCE) with a sulphonated fluorocarbon membrane, and polypyrrole, and poly(1-methylpyrrole) modified membranes operating at 70° C. Assuming that the rate of methanol transport through the cell is practically controlled by the membrane only according to Equation 1, Dₘ values can be obtained by combining the limiting current and the slope of Cottrell plot for each membrane. The results are summarised in the table below.

Methanol diffusion coefficients from
electrochemical measurements

| Temp | | Diffusion Coefficient |
|---|---|---|
| (° C.) | Membrane | (10⁵, cm²/sec) |
| 50 | Unmodified | 0.89 |
| | Modified with polypyrrole | 0.39 |
| | Modified with poly(1-methylpyrrole) | 0.38 |
| 70 | Unmodified | 2.48 |
| | Modified with polypyrrole | 0.79 |
| | Modified with poly(1-methylpyrrole) | 1.32 |

Polymer-modified membranes have a lower diffusion coefficient within the membranes.

Thus the higher inhibition of methanol crossover for the modified membranes is, at least in part, due to the lower diffusion coefficient.

### Example 6

### Preparation of a Fuel Cell By Polymerising 2,2′-Bithiophene into a Sulphonated Fluorocarbon Membrane Matrix

A cleaned, dry Nafion™ membrane was immersed in a solution of 0.1 M 2,2′-bithiophene in acetonitrile for 2 days under air. It was then rinsed with acetontrile and placed in boiling water for 1 hr. The modified membrane exhibited a methanol crossover that was ca. 10% lower than for an unmodified membrane. Its resistance in a half-cell was not significantly higher than for an unmodified membrane.

### Example 7

### Preparation of a Fuel Cell By Polymerising 3,4-Ethylenedioxythiophene into a Sulphonated Fluorocarbon Membrane Matrix

A cleaned, dry Nafion™ membrane was immersed in a solution of 0.1 M 3,4-ethylenedioxythiophene in acetonitrile for 2 days under air. It was then rinsed with acetontrile and placed in boiling water for 1 hr. The modified membrane exhibited a methanol crossover that was ca. 20% o lower than for an unmodified membrane. Its resistance was not significantly higher than for an unmodified membrane.

The Embodiments of the invention in which an exclusive property or privilege is claimed are defined as follows:

1. A fuel cell for use with a fuel, comprising:
(a) an anode;
(b) a cathode; and
(c) an ion exchange membrane modified by in situ polymerisation of monomers on and/or within the membrane, wherein said monomers are aryls, heteroaryls, substituted aryls, substituted heteroaryls or a combination thereof.

2. The fuel cell according to claim 1, wherein said fuel is an organic fuel.

3. The fuel cell according to claim 2, wherein said organic fuel is methanol, dimethoxymethane, trimethoxymethane, ethanol or acetal.

4. The fuel cell according to any one of claims 1, 2 or 3, wherein the ion exchange membrane is a cation exchange membrane.

5. The fuel cell according to claim 4, wherein the cation exchange membrane is a polybenzimidazole membrane.

6. The fuel cell according to any one of claims 1, 2 or 3, wherein the ion exchange membrane is a sulphonated fluorcarbon membrane.

7. The fuel cell according to claim 6, wherein the sulphonated fluorcarbon membrane is Nafion™ or trifluorostyrene.

8. The fuel cell according to claim 1, wherein the monomers are polymerised within the ion exchange membrane.

9. The fuel cell according to claim 1, wherein the monomers are polymerised on and within the ion exchange membrane.

10. The fuel cell according to claim 1, wherein the monomers are pyrrole, 1-methylpyrrole, aniline, 2,2′-bithiophene, or 3,4-ethylene dioxythiophene.

11. The fuel cell according to claim 1, wherein the monomers are polymerised using a chemical oxidant.

12. The fuel cell according to claim 11, wherein the chemical oxidant is hydrogen peroxide, oxygen, Fe³⁺ or S₂O₈²⁻.

13. The fuel cell according to claim 1, wherein the monomers are polymerised using irradiation.

14. The fuel cell according to 13, wherein the irradiation is ultraviolet irradiation.

15. The fuel cell according to claim 1, wherein the membrane has been treated to remove impurities following polymerisation of the monomers.

16. The fuel cell according to claim 15, wherein the impurities include unreacted monomers.

17. The fuel cell according to claim 15, wherein the impurities are removed by washing with an organic solvent, an aqueous acid, or a sequential combination thereof.

18. The fuel cell according to claim 17, wherein said sequential combination consists of:
(a) a first wash using methanol;
(b) a second wash using nitric acid; and
(c) a third wash using sulphuric acid.

19. The fuel cell according to any one of claims 1-18, wherein the modification of the ion exchange membrane reduces fuel crossover.

20. The fuel cell according to any one of claims 1-19, wherein the modification does not affect ion conductivity through the membrane.

21. A method for preparing a fuel cell comprising the step of modifying an ion exchange membrane by in situ polymerisation of monomers on and/or within the membrane, wherein said monomers are aryls, heteroaryls, substituted aryls, substituted heteroaryls or a combination thereof.

22. Use of a modified membrane in a fuel cell, wherein said modified membrane is produced by in situ polymerisation of monomers on and/or within an ion exchange membrane, and wherein said monomers are aryls, heteroaryls, substituted aryls, substituted heteroaryls or a combination thereof.

23. A modified membrane for use in a fuel cell, wherein the modified membrane is produced by in situ polymerisation of monomers on and/or within an ion exchange membrane, wherein said monomers are aryls, heteroaryls, substituted aryls, substituted heteroaryls or a combination thereof.

24. The modified membrane according to claim 23, wherein said monomers are pyrrole, 1-methylpyrrole, aniline, 2,2′-bithiophene, or 3,4-ethylene dioxythiophene.
